(19) United States
(12) Patent Application Publication
(10) Pub. No.: US 2004/0064811 A1
(43) Pub. Date: Apr. 1, 2004

(54) Optimal register allocation in compilers

(75) Inventor: Morrie Altmejd, Austin, TX (US)

Correspondence Address: ZAGORIN O'BRIEN & GRAHAM, L.L.P., 7600B N. CAPITAL OF TEXAS HWY., SUITE 350, AUSTIN, TX, 78731, US

(73) Assignee: Advanced Micro Devices, Inc.

(21) Appl. No.: 10/260,804

(22) Filed: Sep. 30, 2002

(51) Int. Cl. G06F 9/45

(52) U.S. Cl. 717/159

(57) ABSTRACT

An improved register allocation technique is provided. An interference graph coloring is attempted multiple times prior to spilling one or more nodes. Each node has a spill cost derived from the time it takes to store and recall the variable's data combined with how often the compiler thinks the variable is needed. Similarly, each coloring failure has a spill cost which is the accumulation of the spill costs of the remaining un-colorable nodes. If any solutions are found, the process is complete. If only failures are found, the cheapest node(s) to spill is evaluated based on the multiple failures. In one embodiment, the cheapest node of the cheapest failure is spilled. In another embodiment, the cheapest node is evaluated across all failures. This process is repeated until a solution is found (all nodes are colored or spilled).

### BACKGROUND

1. Field of the Invention

This invention relates to register allocation routines in a software compiler and more particularly to an optimized register allocation method utilizing graph coloring.

2. Description of the Related Art

A processor has a limited number of internal registers for storing variables during the execution of a software program. If there are more variables to be stored than available register locations on the processor, some of the variables must be stored (or “spilled”) to alternative locations such as cache, main memory, or disk storage. Storage of variables in these alternative locations is undesirable due to the access latency of these locations. For example, operations where the variables are obtained from and results returned to the processor's registers can continue at a much higher speed than those which require memory or storage access. A processor must wait for variables to be obtained before completing an operation. Thus, it is desirable to spill as few variables to alternative locations as possible.

The decision to spill a variable is not made by the processor during execution. Instead, the decision is made by a compiler during compilation of the original source code into binary code, i.e., the language format understood by the processor. The compiler converts the source code into an intermediate program language to perform optimizations, scheduling of operations, and register allocations. Most compilers assume an arbitrarily large number of virtual registers prior to actual executable code generation. For example, the result of each different computation in the program is typically assigned a different virtual register. During register allocation, the virtual registers are assigned to real registers in the processor or spilled to alternate storage locations.

Register allocation methods typically utilize single pass graph coloring methodologies combined with graph reduction which essentially constitutes eliminating from the graph nodes to be spilled to memory. Various techniques have been used; however, most conform to the flow of FIG. 1. Note that flow 100 contains two alternate methods, technique A and technique B. In both methods, an interference graph is built, step 102. An interference graph is used to represent the conflicts between virtual registers. Each virtual register is a node and the real registers are the available colors. Two nodes are connected with an edge if the two virtual registers are both live at the same point in the program. Thus, the register allocation problem is equivalent to the problem of coloring the graph so that no two connected nodes are colored the same. In other words, if two nodes are adjacent, they are assigned different colors, and therefore, different real registers.

Next, the interference graph is simplified, step 104. Any nodes with the number of edges (degree) less than the number of processor registers can be removed and saved for later coloring. Because the degree is less than the number of available processor registers, the node can necessarily be colored. Additionally, any nodes capable of being coalesced are combined for the purpose of eliminating unnecessary register copy operations. In technique A, the simplification process additionally consists of determining which node(s) to spill. Typically, nodes with the number of edges (degree) greater than the number of processor registers are spilled. In other techniques, the nodes with the lowest ratio of spill cost to degree are spilled. For a node, the spill cost may be defined as the number of additional cycles that would be required to save and restore the node. Alternatively, the spill cost can be estimated to be the number of loads and stores that would have to be inserted in the program, weighted by the loop nesting depth of each insertion point. The spill cost can be pre-computed for each node, such that when the register allocator reaches the point where it must choose a node to spill, it divides the pre-computed spill cost by the node's current degree.

Next in technique A, one or more nodes are spilled and spill code is inserted, step 106. For the node that is to be spilled, the code generated includes program steps, called spill code, which instruct the computer to store the spilled value to memory after definition, and restore the value to a register before its subsequent use in the program. The register allocator of technique A repeats the steps 102, 104, and 106 until the interference graph is colorable. Colors are assigned to nodes until all nodes are colored, step 108. Technique A is an iterative scheme in the sense that the entire process of building the interference graph, simplifying it, and inserting the spill code is repeated until the original graph is reduced to one that is trivial to color. Once enough nodes have been spilled, the coloring process is simply an assignment of nodes to processor registers.

In technique B, after coalescing other nodes in step 104, rather than looking for nodes to be spilled, the register allocator makes a random attempt to color the graph, step 108. If the interference graph is not completely colored in step 108, one or more un-colored nodes are chosen to be spilled and then spill code is inserted, step 106. The choice of nodes to be spilled can be based on the cost of each uncolored node as previously described. Technique B avoids unnecessary spills by postponing spill decisions until after a single random attempt to color the interference graph is made. The register allocator of technique B constructs a new interference graph, step 102, and the process is repeated.

Each of these graph coloring techniques produce different results based on program structure, for example, the number of and depth of nesting in loops. However, program structure often varies from program to program, based on for example, the various programming styles of each programmer. Thus, the register allocation of a compiler produces varying results based on the structure of each program.

For years mathematicians have addressed the difficulty of graph coloring. Graph coloring techniques have been constrained in the amount of computer power and time available. The problem of obtaining a minimal graph coloring is among a class of so-called non-deterministic polynomial-time complete (NP-complete) problems which can take time to solve that is exponentially proportional to the size of the graph. It is widely believed that the problems in the NP-complete class are incapable of being solved in time proportional to a polynomial function of the size of the problem; indeed no polynomial-time bounded solution to an NP-complete problem has yet been found. From the standpoint of register allocation, such exponential performance has been undesirable, since this would lead to impractical time for allocation, and thus for the whole compilation process.

The graph coloring techniques above only attempt to color a graph once before spilling one or more nodes. A backtracking algorithm recursively colors a graph, searching for a solution. However, backtracking algorithms tend to thrash when near the phase transition between solvable and unsolvable graph colorings.

### SUMMARY

Accordingly, in one embodiment, an improved register allocation technique is provided. An interference graph coloring is attempted multiple times prior to spilling one or more nodes. Each node has a spill cost derived from the time it takes to store and recall the variable's data combined with how often the compiler thinks the variable is needed. Similarly, each coloring failure has a spill cost which is the accumulation of the spill costs of the remaining un-colorable nodes. If any solutions are found, the process is complete. If only failures are found, the cheapest node(s) to spill is evaluated based on the multiple failures. In one embodiment, the cheapest node of the cheapest failure is spilled. In another embodiment, the cheapest node is evaluated across all failures. This process is repeated until a solution is found (all nodes are colored or spilled). Thus, many different coloring techniques can be used and each failure is evaluated to determine the optimal node to be spilled.

In another embodiment, a method of register allocation includes coloring an interference graph multiple times creating a plurality of different results, the interference graph having a plurality of nodes. If any of the plurality of different results is a solution, coloring of the interference graph stops. Otherwise, choosing a cheapest cost node from the plurality of nodes to spill.

In another embodiment, choosing the cheapest cost node includes choosing a cheapest cost failure of the plurality of different results and choosing the cheapest cost node from uncolored ones of the plurality of nodes of the cheapest cost failure.

In another embodiment, the cheapest cost failure has the more of the plurality of nodes colored than other of the plurality of different results.

In another embodiment, choosing the cheapest node includes choosing the cheapest node amongst all of the plurality of different results.

In another embodiment, a node has a cost corresponding to a frequency that the node is un-colored in the plurality of different results.

The foregoing is a summary and thus contains, by necessity, simplifications, generalizations and omissions of detail; consequently, those skilled in the art will appreciate that the summary is illustrative only and is not intended to be in any way limiting. As will also be apparent to one of skill in the art, the operations disclosed herein may be implemented in a number of ways, and such changes and modifications may be made without departing from this invention and its broader aspects. Other aspects, inventive features, and advantages of the present invention will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings.

FIG. 1, labeled prior art, illustrates prior art register allocation techniques.

FIGS. 2A-2B illustrate an exemplary compiler architecture according to an embodiment of the present invention.

FIGS. 3A-3C illustrates optimized register allocation techniques according to embodiments of the present invention.

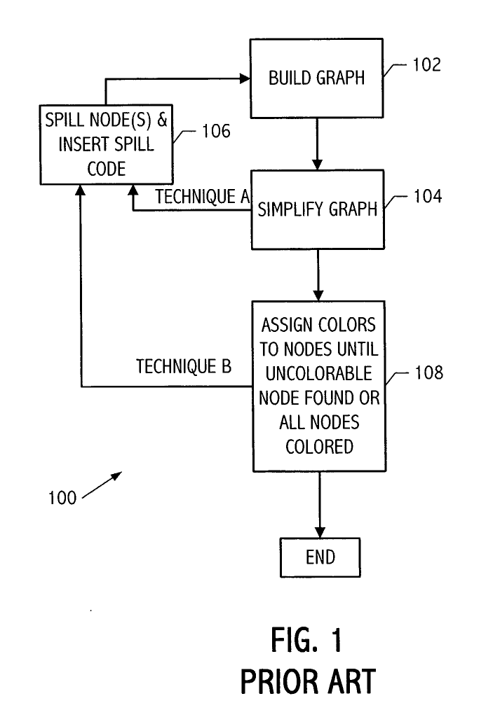

The use of the same reference symbols in different drawings indicates similar or identical items.

### DESCRIPTION OF THE PREFERRED EMBODIMENT(S)

An improved register allocation technique is provided. Previous register allocation techniques were focused on which nodes to spill and improving graph coloring routines. Each of these techniques was constrained in the available processing power and time available to allocate registers. The availability of additional processing power provides different alternatives for improving register allocation. According to the present invention, the interference graph coloring is attempted multiple times prior to spilling one or more nodes. Each node has a spill cost derived from the time it takes to store and recall the variable's data combined with how often the compiler thinks the variable is needed. Similarly, each coloring failure has a spill cost which is the accumulation of the spill costs of the remaining un-colorable nodes. If any solutions are found, the process is complete. If only failures are found, the cheapest node(s) to spill is evaluated based on the multiple failures. In one embodiment, the cheapest node of the cheapest failure is spilled. In another embodiment, the cheapest node is evaluated across all failures. This process is repeated until a solution is found (all nodes are colored or spilled). Thus, many different coloring techniques can be used and each failure is evaluated to determine the optimal node to be spilled.

### Compiler

Register allocation is performed by a compiler prior to run time execution of code. Source code written by a programmer is a list of statements in a programming language such as C, Pascal, Fortran and the like. Programmers perform all work in the source code, changing the statements to fix bugs, adding features, or altering the appearance of the source code. A compiler is a software tool that converts the source code into an executable file that a processor in a computer or other machine can understand. The executable file is in a binary format and is often referred to as binary code. Binary code is a list of instruction codes that a processor of a computer system is designed to recognize and execute. Binary code can be executed over and over again without recompilation. The conversion or compilation from source code into binary code is typically a one-way process. Conversion form binary code back into the original source code is typically impossible.

A different compiler or compiler options is required for each type of source code language and target machine or processor. For example, a Fortran compiler typically can not compile a program written in C source code. Also, processors from different manufacturers typically require different binary code and therefore a different compiler or compiler options because each processor is designed to understand a specific instruction set or binary code.

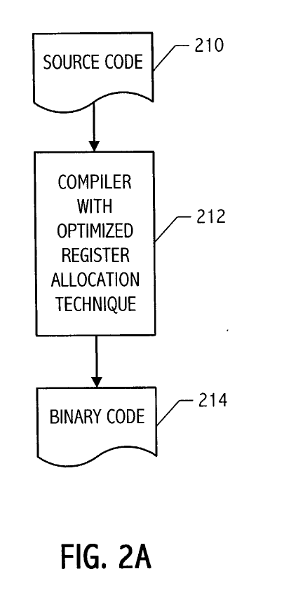

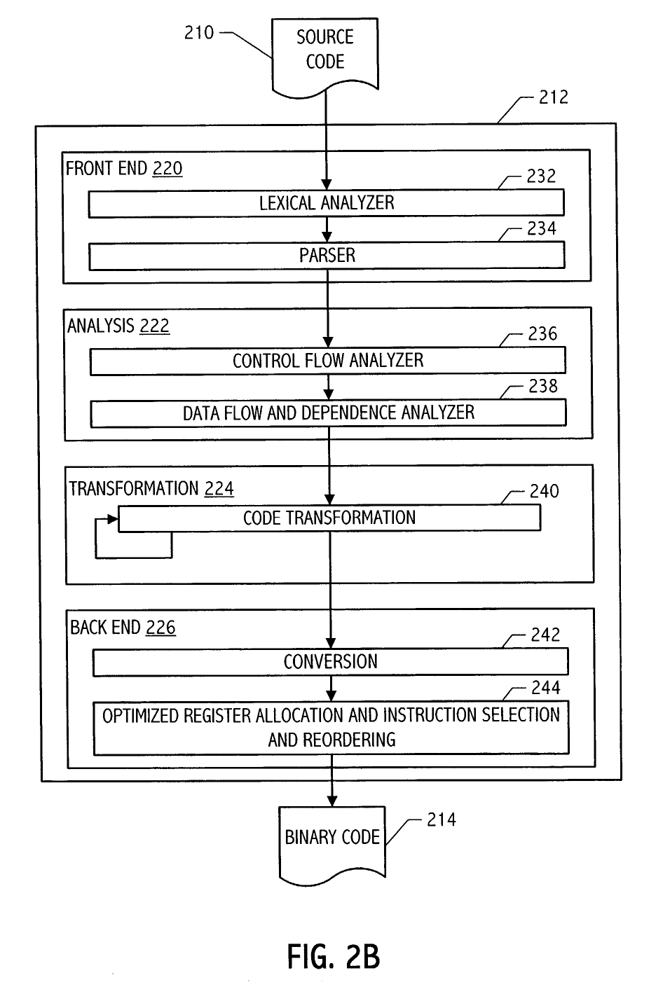

FIG. 2A illustrates an exemplary compilation process according to an embodiment of the present invention. Source code 210 is read into compiler 212. Source code 210 is a list of statements in a programming language such as C, Pascal, Fortran and the like. Compiler 212 with an optimized register allocation technique converts and optimizes all of the statements in source code 210 to produce a binary code 214. Binary code 214 is an executable file in a binary format and is a list of instruction codes that a processor of a computer system is designed to recognize and execute. An exemplary compiler architecture is shown in FIG. 2B according to an embodiment of the present invention.

Note that some implementations may split compiler 212 into two routines. The second routine can be executed at a different time than the first, for example, in batch mode or just before execution in a “just-in-time” mode.

In the compilation process, compiler 212 examines the entire set of statements in source code 210 and collects and reorganizes the statements. Each statement in source code 210 can translate to many machine language instructions or binary code instructions in binary code 214. There is seldom a one-to-one translation between source code 210 and binary code 214. During the compilation process, compiler 212 may find references in source code 210 to programs, sub-routines and special functions that have already been written and compiled. Compiler 212 typically obtains the reference code from a library of stored sub-programs which is kept in storage and inserts the reference code into binary code 214. Binary code 214 is often the same as or similar to the machine code understood by a computer. If binary code 214 is the same as the machine code, the computer can run binary code 214 immediately after compiler 212 produces the translation. If binary code 214 is not in machine language, other programs (not shown)such as assemblers, binders, linkers, and loaders-finish the conversion to machine language. Compiler 212 differs from an interpreter, which analyzes and executes each line of source code 210 in succession, without looking at the entire program.

FIG. 2B illustrates an exemplary compiler architecture for compiler 212 with an optimizing register allocation technique according to an embodiment of the present invention. Compiler architectures can vary widely; the exemplary architecture shown in FIG. 2B includes common functions that are present in most compilers. Other compilers can contain fewer or more functions and can have different organizations. Compiler 212 contains a front-end function 220, an analysis function 222, a transformation function 224, and a back-end function 226.

Front-end function 220 is responsible for converting source code 210 into more convenient internal data structures and for checking whether the static semantic constraints of the source code language have been properly satisfied. Front-end function 220 typically includes two phases, a lexical analyzer 232 and a parser 234. Lexical analyzer 232 separates characters of the source language into groups that logically belong together; these groups are referred to as tokens. The usual tokens are keywords, such as DO or IF, identifiers, such as X or NUM, operator symbols, such as <=or +, and punctuation symbols such as parentheses or commas. The output of lexical analyzer 232 is a stream of tokens, which is passed to the next phase, parser 234. The tokens in this stream can be represented by codes, for example, DO can be represented by 1,+by 2, and “identifier” by 3. In the case of a token like “identifier,” a second quantity, telling which of those identifiers used by the code is represented by this instance of token “identifier,” is passed along with the code for “identifier.” Parser 234 groups tokens together into syntactic structures. For example, the three tokens representing A+B might be grouped into a syntactic structure called an expression. Expressions might further be combined to form statements. Often the syntactic structure can be regarded as a tree whose leaves are the token. The interior nodes of the tree represent strings of tokens that logically belong together.

Analysis function 222 can take many forms. A control flow analyzer 236 produces a control-flow graph (CFG). The control-flow graph converts the different kinds of control transfer constructs in a source code 210 into a single form that is easier for compiler 212 to manipulate. A data flow and dependence analyzer 238 examines how data is being used in source code 210. Analysis function 222 typically uses program dependence graphs and static single-assignment form, and dependence vectors. Some compilers only use one or two of the intermediate forms, while others use entirely different ones.

After analyzing source code 210, compiler 212 can begin to transform source code 210 into a high-level representation. Although FIG. 2B implies that analysis function 222 is complete before transformation function 224 is applied, in practice it is often necessary to re-analyze the resulting code after source code 210 has been modified. The primary difference between the high-level representation code and binary code 214 is that the high-level representation code need not specify the registers to be used for each operation.

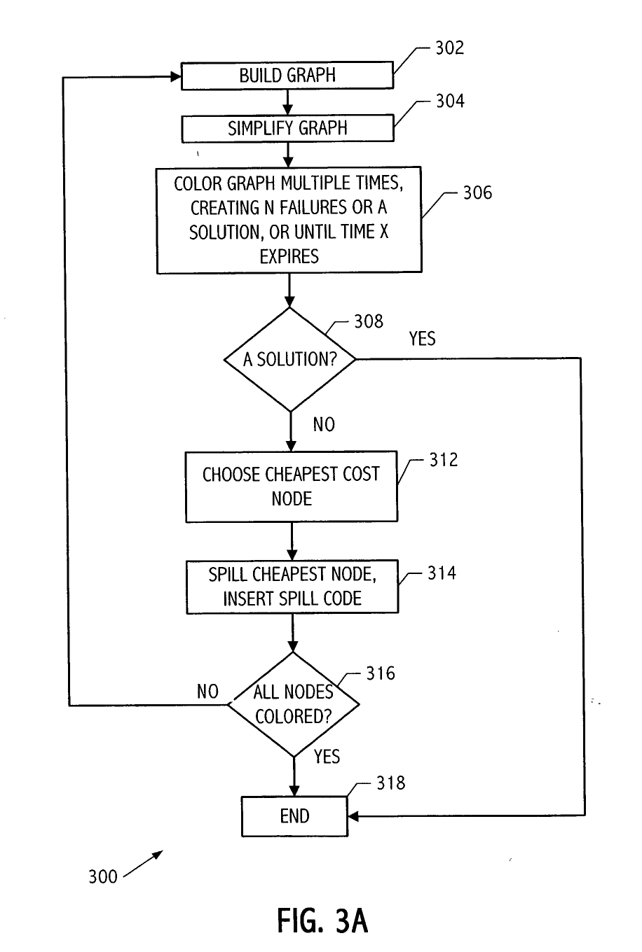

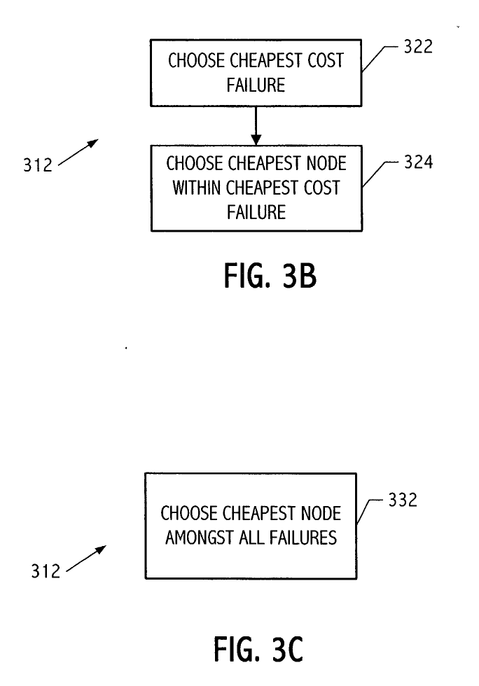

Once source code 210 has been fully transformed into a high-level representation, the last stage of compilation is to convert the resulting code into binary code 214. Back-end function 226 contains a conversion function 242 and an optimized register allocation and instruction selection and reordering function 244. Conversion function 242 converts the high-level representation used during transformation into a low-level register-transfer language (RTL). RTL can be used for register allocation, instruction selection, and instruction reordering to exploit processor scheduling policies. The optimized register allocation technique utilized by the optimized register allocation and instruction selection and reordering function 244 is described below in relation to FIGS. 3A-3C.

A table-management portion (not shown) of compiler 212 keeps track of the names use by the code and records essential information about each, such as its type (integer, real, floating point, etc.). The data structure used to recode this information is called a symbol table.

### Optimized Register Allocation

FIG. 3A illustrates an improved register allocation flow 300 for register allocation according to an embodiment of the present invention. An interference graph is built, step 302. For example, each virtual register generated by the compiler is a node in the interference graph and the real registers (processor registers) are different colors. Two nodes are connected with an edge if the two virtual registers are both live at the same point in the program. Thus, register allocation of flow 300 colors the interference graph so that no two connected nodes are colored the same. In other words, if two nodes are adjacent, they are assigned different colors, and therefore, different processor registers. In this process it is possible that some nodes must be spilled. The intent of the algorithm is to choose variables to spill that least affect performance of the resulting executable code.

The interference graph is simplified without spilling any nodes by, for example, removing nodes with fewer edges than the available registers and coalescing nodes, step 304. Because the number of edges is less than the number of available processor registers, the node can necessarily be colored. Additionally, any nodes capable of being coalesced are combined for the purpose of eliminating unnecessary register copy operations.

Next, the graph is colored producing N failures or a solution, or until time X has expired, step 306. N, the number of times the graph is attempted to be colored, is a predetermined number to limit the amount of time process 300 runs. Alternatively, processing can be limited to a predetermined amount of time, X. Once a solution is found, processing need not proceed further. Different graph coloring techniques are used for each attempt, resulting in N different failures and/or solution. For example, the graph can be colored N times using a backtracking algorithm and saving each intermediate failure. A backtracking algorithm assigns colors to each node, then when the algorithm meets a roadblock (i.e., it cannot color a node), the algorithm backtracks the coloring of nodes and re-colors the interference graph differently. Recursive backtracking algorithms are typically used to search for a solution. According to the present invention, by saving the intermediate failures, a backtracking algorithm is utilized to generate N different failures and/or solutions.

N, the number of times the graph is colored prior to spilling one or more nodes, is an integer greater than one. Because the problem of obtaining a minimal graph coloring is an NP-complete problem which can take time to solve that is exponentially proportional to the size of the graph, the choice of N is carefully determined. N can be chosen according to the computational time available. For example, if M amount of time is available for the register allocation process, it takes K amount of time for each graph coloring, and R is the estimated number of nodes that will be spilled before the graph is colored or alternatively, the estimated number of recursions through flow 300, N can be determined such that N=M/(R*K). Alternatively, N can be chosen according to a dynamically generated recursion limit based on, for example, the structure of the program and the nesting depth of a function. The compiler can also evaluate the spill costs for some blocks and assign extra time for blocks that are executed often. The compiler can determine how often blocks are executed from both flow analysis and feedback from profiling tools that analyze code performance at runtime. The compiler can also budget total compile time available and take advantage of the fact that some blocks take less graph coloring time and reallocate that time to more difficult blocks.

A determination is made whether there is a solution, step 308. A solution is a completely colored graph, that is, with out any uncolored nodes, not including already spilled nodes. If there is a solution, processing is complete.

If there are not any solutions, the cheapest node is chosen to be spilled, step 312. Alternate examples of the determination of the cheapest node are illustrated in FIGS. 3B-3C. Next, spill code is inserted, step 314. For the node that is to be spilled, the original program must be modified to include program steps, called spill code, which instruct the computer to store the spilled value to memory after definition, and restore the value to a register before its subsequent use in the program. According to another embodiment of the present invention, more than one cheapest cost node can be chosen to be spilled.

A determination is made whether all nodes are colored, step 316. If so, the graph coloring is finished. If not, the graph is re-built, step 302, albeit minus the spilled nodes and flow 300 continues until all nodes are successfully colored or spilled.

FIG. 3B illustrates one example of the determination of the cheapest node according to an embodiment of the present invention. The cheapest cost failure is determined, step 322. The cheapest cost failure can be determined by a variety of methods. For example, the failure with the most colored nodes can be given a lower cost than one with only a few nodes colored. Additionally, the cost of each un-colored node can be added up for each failure and the failure with the lowest total cost can be given a lower cost than other failures.

Next, the cheapest cost node within the cheapest cost failure is determined, step 324. Traditional methods of determining the cost of a node can be used. For example, nodes with the number of edges (degree) greater than the number of processor registers are spilled. Additionally, the nodes with the lowest ratio of spill cost to degree are spilled. For a node, the spill cost can be defined as the number of additional cycles that would be required to save and restore the node. Alternatively, the spill cost can be estimated to be the number of loads and stores that would have to be inserted in the program, weighted by the loop nesting depth of each insertion point. The spill cost can be pre-computed for each node, such that when the register allocator reaches the point where it must choose a node to spill, it divides the precomputed spill cost by the node's current degree.

FIG. 3C illustrates another example of the determination of the cheapest node according to an embodiment of the present invention. The cheapest cost node amongst all failures is chosen. The cost of each node can vary based on the characteristics of the failures. Those uncolored nodes which are common to all failures can be given a higher cost than uncolored nodes which occur in just a few of the failures. Additionally, uncolored nodes for almost-complete colorings can be given a higher cost than uncolored nodes of colors with only a few nodes colored.

According to the present invention, the interference graph coloring is attempted multiple times prior to choosing a node to be spilled. Various graph coloring techniques produce different results based on code structure, for example, the number of and depth of nesting in loops. Thus, by using multiple graph coloring techniques and producing multiple graph colorings, optimum node choices for spilling can be determined.

Realizations in accordance with the present invention have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the exemplary configurations may be implemented as a combined structure or component. These and other variations, modifications, additions, and improvements may fall within the scope of the invention as defined in the claims that follow.

What is claimed is:

1. A method of register allocation comprising:
coloring an interference graph multiple times creating a plurality of different results, the interference graph having a plurality of nodes;
if any of the plurality of different results is a solution, discontinuing the coloring of the interference graph; and
otherwise, choosing a cheapest cost node from the plurality of nodes to spill.

2. The method as recited in claim 1, wherein the choosing the cheapest cost node comprises:
choosing a cheapest cost failure of the plurality of different results; and
choosing the cheapest cost node from uncolored ones of the plurality of nodes of the cheapest cost failure.

3. The method as recited in claim 2, wherein the cheapest cost failure has more of the plurality of nodes colored than other of the plurality of different results.

4. The method as recited in claim 1, wherein the choosing the cheapest cost node comprises:
choosing the cheapest cost node amongst all of the plurality of different results.

5. The method as recited in claim 4, wherein a node has a cost corresponding to a frequency that the node is un-colored in the plurality of different results.

6. The method as recited in claim 4, wherein the choosing the cheapest cost node amongst all of the plurality of different results comprises:
assigning a higher cost to un-colored nodes of a most complete coloring of the plurality of different results.

7. The method as recited in claim 1, further comprising:
spilling the cheapest cost node; and
repeating the coloring the interface graph and the choosing the cheapest cost node until all of the plurality of nodes are either colored or spilled.

8. The method as recited in claim 1, wherein the coloring the interference graph multiple times creating the plurality of different results comprises:
performing a backtracking algorithm; and
saving intermediate failures as the plurality of different results.

9. The method as recited in claim 1, wherein the coloring the interference graph multiple times creating the plurality of different results comprises:
performing a different coloring algorithm for each of the plurality of different results.

10. The method as recited in claim 1, wherein a total number of multiple times that the interference graph is colored is determined based on a maximum completion time allotted.

11. The method as recited in claim 1, wherein a total number of multiple times that the interference graph is colored is a dynamically generated recursion limit.

12. The method as recited in claim 1, further comprising choosing more than one cheapest cost node to spill.

13. A binary code produced by the method as recited in claim 1.

14. A computer program product comprising:
a set of software instructions stored on computer readable media, the set of software instructions configured to:
color an interference graph multiple times creating a plurality of different results, the interference graph having a plurality of nodes;
if any of the plurality of different results is a solution, discontinue the coloring of the interference graph; and
otherwise, choose a cheapest cost node from the plurality of nodes to spill.

15. The computer program product as recited in claim 14, wherein to choose the cheapest cost node, the set of software instructions is further configured to:
choose a cheapest cost failure of the plurality of different results; and
choose the cheapest cost node from uncolored ones of the plurality of nodes of the cheapest cost failure.

16. The computer program product as recited in claim 15, wherein the cheapest cost failure has more of the plurality of nodes colored than other of the plurality of different results.

17. The computer program product as recited in claim 14, wherein to choose the cheapest cost node, the set of software instructions is further configured to:
choose the cheapest cost node amongst all of the plurality of different results.

18. The computer program product as recited in claim 17, wherein a node has a cost corresponding to a frequency that the node is un-colored in the plurality of different results.

19. The computer program product as recited in claim 17, wherein to choose the cheapest cost node amongst all of the plurality of different results, the set of software instructions is further configured to:
assign a higher cost to un-colored nodes of a most complete coloring of the plurality of different results.

20. The computer program product as recited in claim 14, the set of software instructions further configured to:
spill the cheapest cost node; and
repeat the coloring the interface graph and the choosing the cheapest cost node until all of the plurality of nodes are either colored or spilled.

21. The computer program product as recited in claim 14, wherein to color the interference graph multiple times creating the plurality of different results, the set of software instructions is further configured to:
perform a backtracking algorithm; and
save intermediate failures as the plurality of different results.

22. The computer program product as recited in claim 14, wherein to color the interference graph multiple times creating the plurality of different results, the set of software instructions is further configured to:
perform a different coloring algorithm for each of the plurality of different results.

23. The computer program product as recited in claim 14, wherein a total number of multiple times that the interference graph is colored is determined based on a maximum completion time allotted.

24. The computer program product as recited in claim 14, wherein a total number of multiple times that the interference graph is colored is a dynamically generated recursion limit.

25. The computer program product as recited in claim 14, the set of software instructions further configured to choose more than one cheapest cost node to spill.

26. An apparatus comprising:
means for coloring an interference graph multiple times creating a plurality of different results, the interference graph having a plurality of nodes;
means for discontinuing the coloring of the interference graph if any of the plurality of different results is a solution; and
means for choosing a cheapest cost node from the plurality of nodes to spill otherwise.

27. The apparatus as recited in claim 26, wherein the means for choosing the cheapest cost node comprises:
means for choosing a cheapest cost failure of the plurality of different results; and
means for choosing the cheapest cost node from uncolored ones of the plurality of nodes of the cheapest cost failure.

28. The apparatus as recited in claim 27, wherein the cheapest cost failure has more of the plurality of nodes colored than other of the plurality of different results.

29. The apparatus as recited in claim 26, wherein the means for choosing the cheapest cost node comprises:
means for choosing the cheapest cost node amongst all of the plurality of different results.

30. The apparatus as recited in claim 29, wherein a node has a cost corresponding to a frequency that the node is un-colored in the plurality of different results.

31. The apparatus as recited in claim 29, wherein the means for choosing the cheapest cost node amongst all of the plurality of different results comprises:
means for assigning a higher cost to un-colored nodes of a most complete coloring of the plurality of different results.

32. The apparatus as recited in claim 26, further comprising:
means for spilling the cheapest cost node; and
means for repeating the coloring the interface graph and the choosing the cheapest cost node until all of the plurality of nodes are either colored or spilled.

33. The apparatus as recited in claim 26, wherein the means for coloring the interference graph multiple times creating the plurality of different results comprises:
means for performing a backtracking algorithm; and
means for saving intermediate failures as the plurality of different results.

34. The apparatus as recited in claim 26, wherein the means for coloring the interference graph multiple times creating the plurality of different results comprises:
means for performing a different coloring algorithm for each of the plurality of different results.

35. The apparatus as recited in claim 26, wherein a total number of multiple times that the interference graph is colored is determined based on a maximum completion time allotted.

36. The apparatus as recited in claim 26, wherein a total number of multiple times that the interference graph is colored is a dynamically generated recursion limit.

37. The apparatus as recited in claim 26, further comprising means for choosing more than one cheapest cost node to spill.
